(19) United States
(12) Patent Application Publication
(10) Pub. No.: US 2005/0225309 A1
(43) Pub. Date: Oct. 13, 2005

(54) Support device for an optical element wherein the shape of a thin plate-type member is made into a shape facilitating mold processing, method of manufacture thereof and manufacturing device

(75) Inventor: Tetsuo Ikegame, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Olympus Corporation, Tokyo (JP)

(21) Appl. No.: 11/131,793

(22) Filed: May 17, 2005

Related U.S. Application Data
(63) Continuation of application No. PCT/JP03/15585, filed on Dec. 5, 2003.

(30) Foreign Application Priority Data
Dec. 11, 2002 (JP) 2002-359687

(51) Int. Cl. B29D 11/00

(52) U.S. Cl. 324/96

(57) ABSTRACT

In a support device for an optical element comprising a coil holder that holds an optical element and a fixing unit that supports the coil holder with a thin plate-type spring in displaceable fashion in at least one direction, one end member of the spring is plastic-insert molded in a condition with a projection of the end on the side of the moveable unit exposed and an extension thereof inserted in the coil holder, while the other end of the spring on the side of the fixing unit is plastic-insert molded in a condition with a projection of the end on the side of the fixing unit exposed and an extension thereof inserted in the fixing unit.

### CROSS REFERENCE TO RELATED APPLICATION

This application is a continuation application of PCT/JP03/15585 filed on Dec. 5, 2003 and claims benefit of Japanese Application No. 2002-359687 filed in Japan on Dec. 11, 2002, the entire contents of each of which are incorporated herein by their reference.

### BACKGROUND OF THE INVENTION

1. Field of the Invention

The present invention relates to a support device for an optical element such as a galvanomirror or objective lens actuator employed, for instance, in a magneto optical disk drive, write-once optical disk drive, phase change optical disk drive, an information reproduction device that records and reproduces information in respect of optical recording media such as a CD-ROM, DVD or optical card, or in an optical device such as an optical scanner or optical deflector for optical communication, and method of manufacture thereof and manufacturing device.

2. Related Art Statement

Conventionally, a device of this type that supports an optical element such as a galvanomirror or objective lens actuator is frequently employed in for example a magneto optical disk drive, write-once optical disk drive, phase change optical disk drive, an information reproduction device that records and reproduces information in respect of optical recording media such as a CD-ROM, DVD or optical card, or in an optical device such as an optical scanner or optical deflector for optical communication.

FIG. 17 is an exploded perspective view showing an example of a prior art support device for an optical element as described above. FIG. 18 is a plan view showing an example of a prior art support device for an optical element as described above.

The support device 200 for an optical element comprises a first moveable bobbin 201 that supports an objective lens, not shown, a second moveable bobbin 205 that supports drive coils comprising a focusing coil 202 and tracking coils 203, 204, a first fixed bobbin 208 that supports the first moveable bobbin 201 by means of suspensions 206, 207 and a second fixed bobbin 211 that supports the second moveable bobbin 205 by means of suspensions 209 and 210 (Japanese Patent Application Laid-open No. 8-306059).

In a prior art, the method of manufacturing an optical element support device 200 having such construction is as follows: when insertion molding for suspensions 206, 207 formed on a metal plate 241 is performed onto the first moveable bobbin 201 that holds an objective lens and/or a drive coil and the first fixed bobbin 208 that holds the first moveable bobbin 201 by means of suspensions 206, 207, molding is conducted by arranging for the suspension ends 222, 223 that are inserted at least in the first moveable bobbin 201 so as to be pressed by a metal mold (Japanese Patent Application Laid-open No. 8-306059).

In ordinary resin molding, it is necessary to ensure that flash is not formed by outflow of resin from the mating surfaces of the metal molds by pushing together the mating surfaces of each of moveable metal mold, fixed metal mold and slidable metal mold, such that no clearance are produced at the mating surfaces. The reason for this is that if flash is produced, problems occur such as this flash contacting other members, or adverse effects on external tolerance.

In the prior art method of manufacturing a support device for an optical element as described above, it is likewise necessary to ensure that resin flash is not produced at the periphery of the ends 222, 223 of suspensions 206, 207 when the ends 222, 223 of suspensions 206, 207 formed on the metal plate 241 are insertion-molded by resin. This will be further described with reference to FIG. 19.

FIG. 19 is a partial sectional view of an example of a prior art metal mold employed in a method of manufacturing a support device for an optical element, being a reference view of the sectional view shown along the line A-A of FIG. 18.

An outline of the prior art method of manufacturing a support device for an optical element is as follows. First of all, positioning is effected by means of positioning holes 241a of a metal plate 241 formed with suspensions 206, 207 on a fixed metal mold 310 and the mating surfaces are then brought into contact by placing a moveable metal mold 320 on top of the fixed metal mold 310, and the support device 200 for the optical element is formed as shown in FIG. 17 and FIG. 18 by allowing resin to flow into a first moveable bobbin molding recess 330 and fixed bobbin molding recess.

Also, as shown in FIG. 19, a recess 311 for clamping the suspension 207 is formed in the fixed metal mold 310. Since the distance L between the first moveable bobbin molding recess 330 for molding the first moveable bobbin 201 and the suspension 207 is narrow, as shown in FIG. 19, a projection 312 must be formed in the fixed metal mold 310 between the recess 311 and the first moveable bobbin molding recess 330. If the projection 312 were not provided, resin would flow from the first moveable bobbin molding recess 330 into the recess 311, interfering with the flexing action of the suspension 207. In order to prevent this, as described above, the projection 312 must be provided in the fixed metal mold 310 between the recess 311 and the first moveable bobbin molding recess 330, so as to eliminate clearance at portions where there is not the moveable bobbin 210 nor suspension 207 between the fixed metal mold 310 and moveable metal mold 320.

### SUMMARY OF THE INVENTION

A support device for an optical element according to the present invention comprises: a holder having at least an optical element; and a fixing unit that supports the holder moveably in at least one direction by means of a thin plate-type spring; wherein the support device further comprises a first insertion molding portion in which the holder is insertion molded in a condition with a first portion of the spring inserted into the holder molding portion and/or a second insertion molding portion in which the fixing unit is insertion molded in a condition with a second portion of the spring inserted in the fixing unit molding portion; and the thickness of the spring defines a clearance space of mating faces of a metal mold forming the holder and/or the fixing unit at least in the vicinity of the spring.

Other features and advantages of the present invention will be fully clarified by the following description.

### BRIEF DESCRIPTION OF THE DRAWINGS

FIG. 1 to FIG. 13 relate to the first embodiment of the present invention.

FIG. 1 is a view given in explanation of the principles of an optical deflection device in an optical path changeover device for optical communication serving as a support device for an optical element;

FIG. 2 is a perspective view given in explanation of a specific constructional example of an optical deflection device to which the support device for an optical element has been applied;

FIG. 3 is an exploded perspective view given in explanation of a specific constructional example of an optical deflection device to which the support device for an optical element has been applied;

FIG. 4 is a sectional view given in explanation of a specific constructional example of an optical deflection device to which the support device for an optical element has been applied;

FIG. 5 is a front perspective view showing an optical deflector to which the support device for an optical element has been applied;

FIG. 6 is a rear perspective view showing an optical deflector to which the support device for an optical element has been applied;

FIG. 7 is an exploded perspective view showing an optical deflector to which the support device for an optical element has been applied;

FIG. 8 is a sectional view showing to a larger scale an optical deflector to which the support device for an optical element has been applied;

FIG. 9 is a view showing the condition in which the stopper and cover of an optical deflector employed in an optical deflector, to which the support device for an optical element has been applied, have been removed;

FIG. 10 is a plan view showing a spring sheet employed in a method of manufacturing a support device for an optical element;

FIG. 11 is a view showing to a larger scale a single spring body of the spring sheet employed in the method of manufacturing a support device for an optical element;

FIG. 12 is a view showing a metal mold used in a method of manufacturing a support device for an optical element; and

FIG. 13 is a sectional view showing to a larger scale part of a metal mold used in the method of manufacturing a support device for an optical element.

FIG. 14 to FIG. 16 relate to a second embodiment of the present invention.

FIG. 14 is a plan view given in explanation of a method of manufacturing a support device for an optical element;

FIG. 15 is a sectional view given in explanation of a method of manufacturing a support device for an optical element; and

FIG. 16 is an exploded perspective view showing a support device for an objective lens manufactured by a method of manufacturing a support device for an optical element.

FIG. 17 to FIG. 19 relate to prior art.

FIG. 17 is an exploded perspective view showing an example of a prior art support device for an optical element;

FIG. 18 is a plan view showing an example of a prior art support device for an optical element; and

FIG. 19 is a sectional view shown along the line A-A of FIG. 18.

### DETAILED DESCRIPTION OF THE PREFERRED EMBODIMENTS

Before describing the method of manufacturing a support device for an optical element according to an embodiment of the present invention, the first of all, the construction of a support device for an optical element will be described and then a method of manufacturing a support device for an optical element will be described.

(Principles of an Optical Deflection Device to which the Support Device for an Optical Element is Applied)

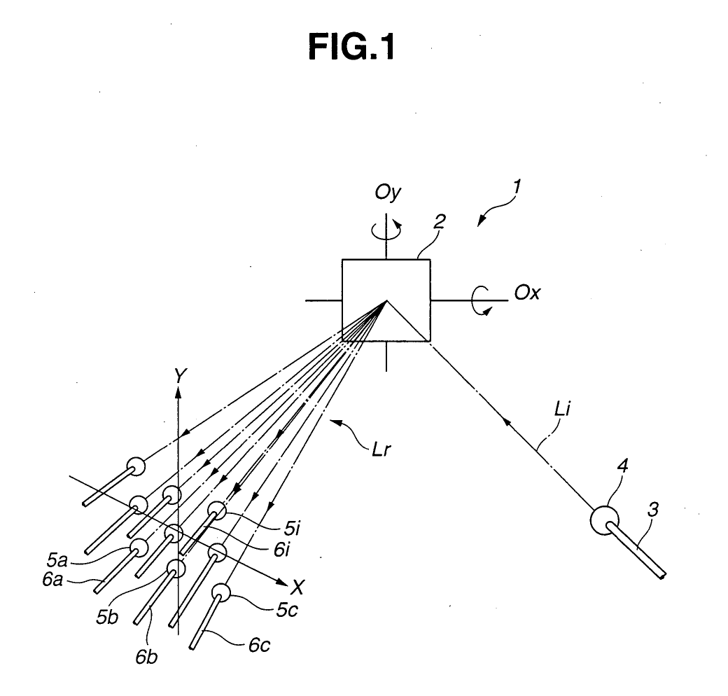

FIG. 1 is a view given in explanation of the principles of an optical deflection device in an optical path changeover device for optical communication serving as a support device for an optical element according to an embodiment of the present invention.

In FIG. 1, an optical deflection device in an optical path changeover device for optical communication is employed for changeover of optical path for optical communication and comprises: a mirror 2 capable of being selectively driven about an axis of rotation Ox parallel with the X axis and an axis of rotation Oy parallel with the Y axis, which is perpendicular to the X axis, an optical fiber 3 for optical output, a lens 4 arranged to make the light issued from the optical fiber 3 into a collimated beam to supply to the mirror 2, photoreceiving lenses 5a to 5i arranged in three rows on a perpendicular plane such that the light from the mirror 2 can be photoreceived, and optical fibers 6a to 6i arranged at the converging positions of the photoreceiving lenses 5a to 5i.

An incident beam Li for optical communication that is emitted as a collimated beam by the lens 4 from a single optical fiber 3 is projected onto the mirror 2. Being driven selectively about the optical axis Ox and optical axis Oy, the mirror 2 can supply a reflected light Lr to any one of the optical fibers 6a to 6i by making incident this reflected light Lr selectively onto any one of the photoreceiving lenses 5a to 5i.

(Overall Construction of the Optical Deflection Device)

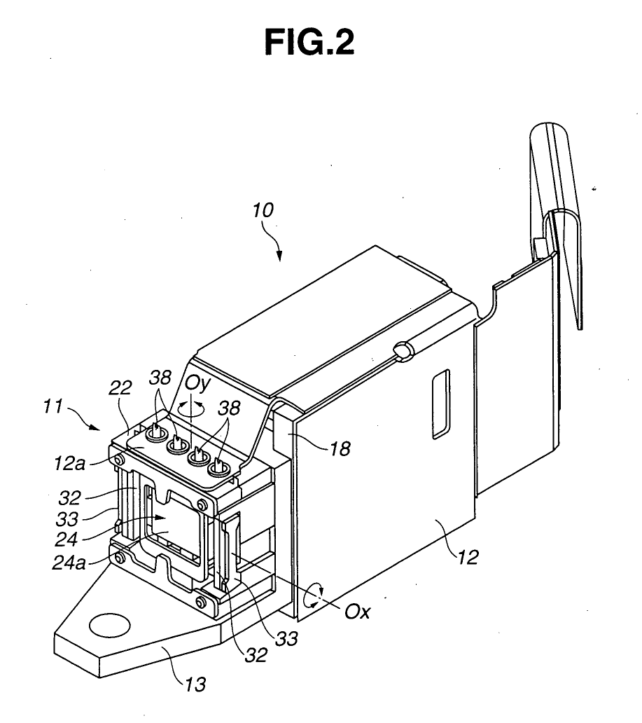

A specific example of the construction of an optical deflection device according to such principles is described with reference to FIG. 2 to FIG. 4.

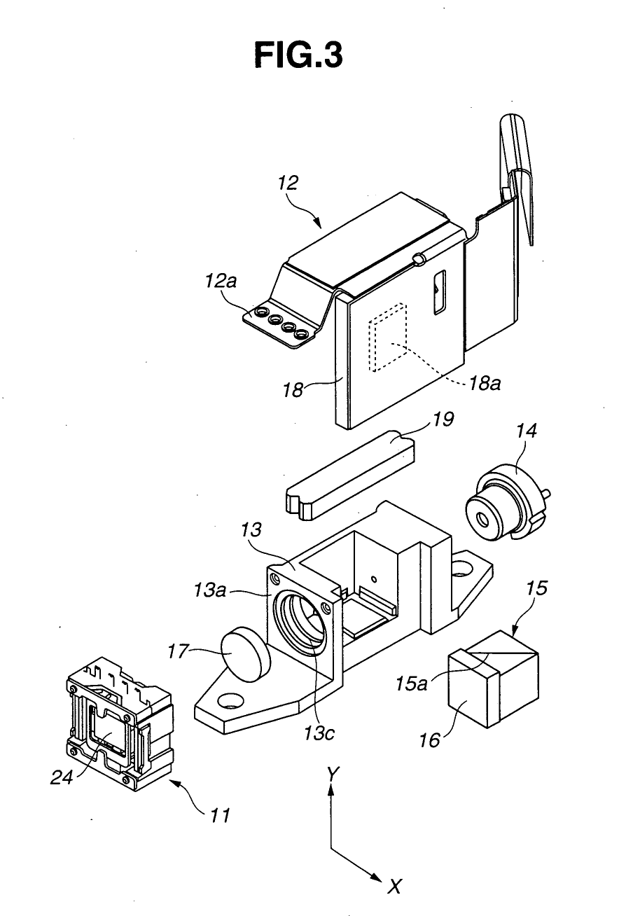

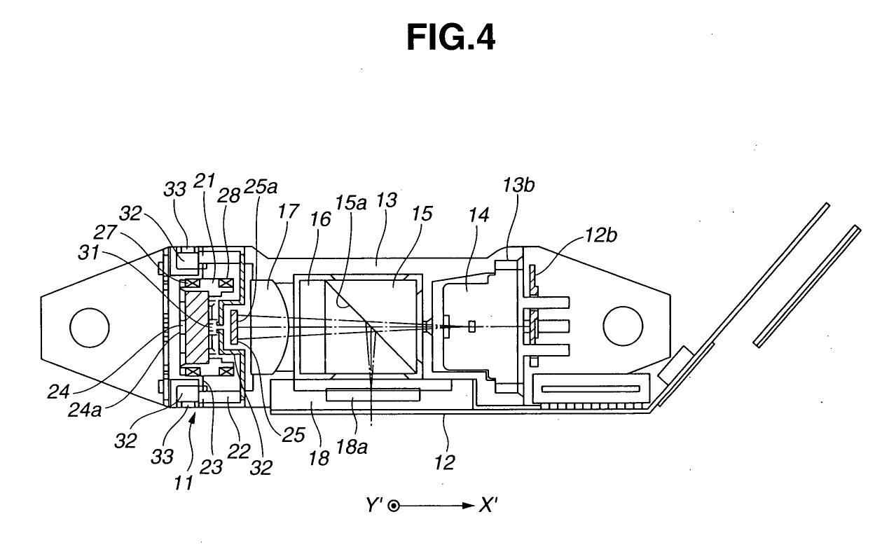

FIG. 2 is a perspective view given in explanation of a specific example of the construction of an optical deflection device to which a support device for an optical element according to an embodiment of the present invention has been applied. FIG. 3 is an exploded perspective view given in explanation of a specific constructional example of an optical deflection device to which the support device for an optical element according to an embodiment of the present invention has been applied. FIG. 4 is a sectional view given in explanation of a specific constructional example of an optical deflection device to which the support device for an optical element according to an embodiment of the present invention has been applied.

In these Figures, an optical deflection device 10 basically comprises an optical deflector 11, FPC 12, housing 13, semiconductor laser 14, polarizing beam splitter 15, ¼ wavelength plate 16, condensing lens 17, semiconductor position detector 18 and spacer 19.

(Specific Construction of the Optical Deflector 11)

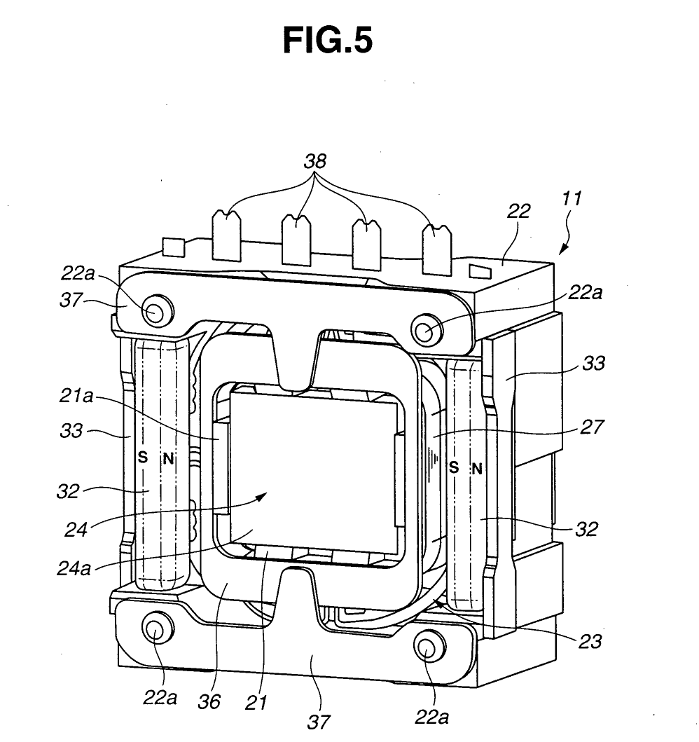

Next, the optical deflector 11 of the optical deflection device 10 will be described in further detail with reference to FIG. 5 to FIG. 9, based on FIG. 2 to FIG. 4.

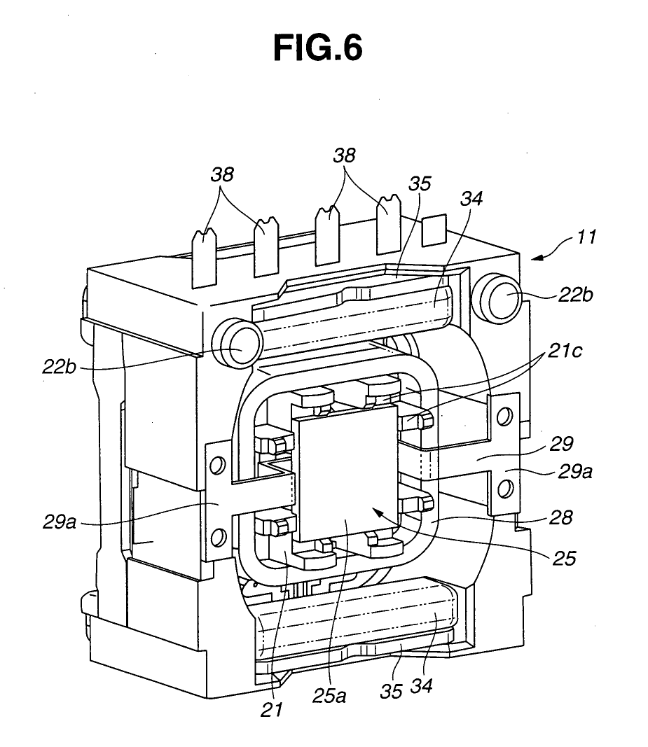

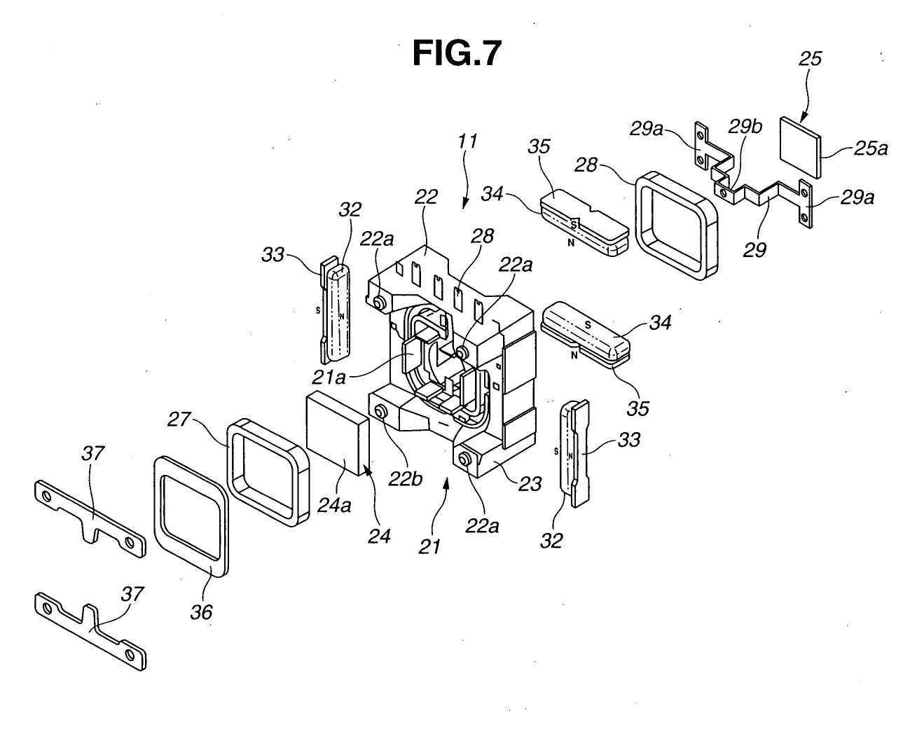

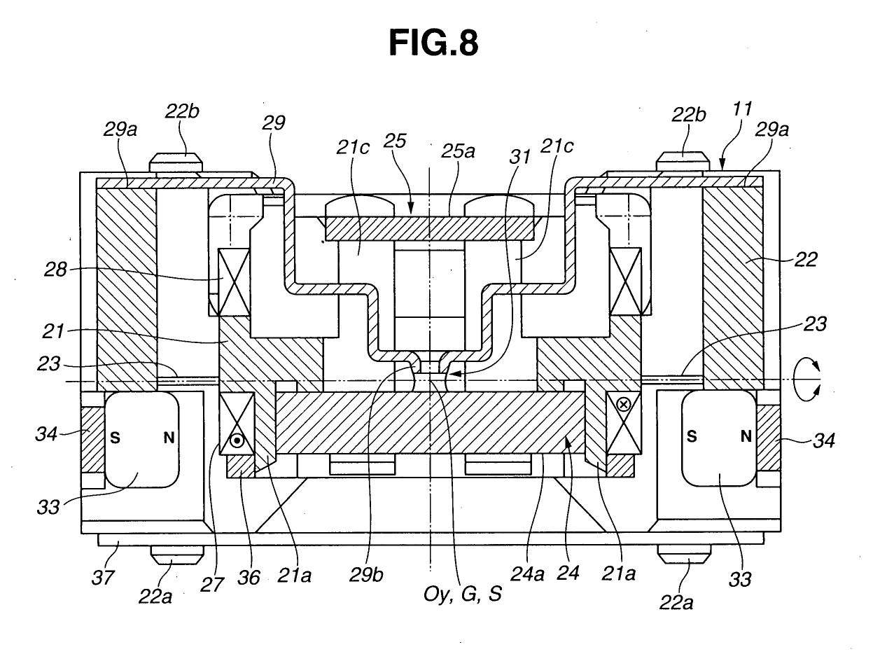

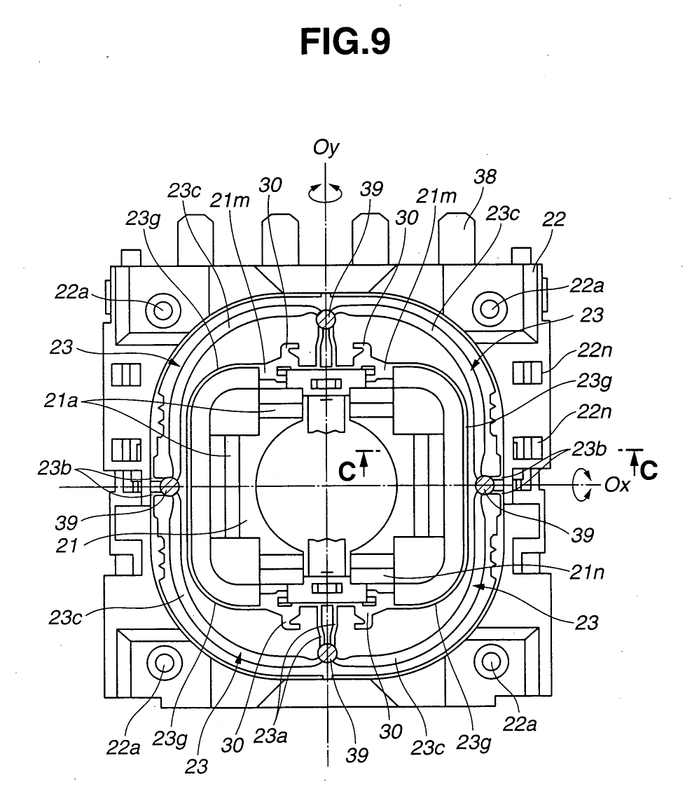

FIG. 5 is a front perspective view showing an optical deflector to which the support device for an optical element according to an embodiment of the present invention has been applied. FIG. 6 is a rear perspective view showing an optical deflector to which the support device for an optical element according to an embodiment of the present invention has been applied. FIG. 7 is an exploded perspective view showing an optical deflector to which the support device for an optical element according to an embodiment of the present invention has been applied. FIG. 8 is a sectional view showing to a larger scale an optical deflector to which the support device for an optical element according to an embodiment of the present invention has been applied. FIG. 9 is a view showing the condition in which the stopper and cover of an optical deflector employed in an optical deflector to which the support device for an optical element according to an embodiment of the present invention has been applied have been removed.

In these Figures, as shown in FIG. 2 to FIG. 9, the optical deflector 11 comprises a coil holder 21 constituting part of a moveable unit, a magnet holder 22 constituting a fixing unit and four plate-type springs 23, 23, 23, 23; the coil holder 21 is moveably fixed on the magnet holder 22 by means of the springs of 23, 23, 23, 23.

When the coil holder 21 and the magnet holder 22 are molded out of non-conductive plastic, the ends of four springs 23, 23, 23, 23 made for example of beryllium copper foil of thickness 20 μm whose surface has been gold-plated after etching are fixed with the moveable ends thereof being insertion molded in the coil holder 21 and the fixed ends thereof being insertion molded in the magnet holder 22. For the non-conductive plastic, for example liquid-crystal polymer containing titanate whiskers or liquid-crystal polymer containing glass fibers was employed.

As shown in FIG. 9, one ends of the four springs 23, 23, 23, 23 are fixed at two locations respectively on both sides in the vicinity of the axis of rotation Oy of the coil holder 21 and first deformation sections 23a parallel with the axis of rotation Oy are formed in the vicinity of the fixed ends thereof. Also, as shown in FIG. 9, the other ends of the springs 23, 23, 23, 23 are fixed at two locations respectively on both sides in the vicinity of the axis of rotation Ox of the magnet holder 22 and second deformation sections 23b are formed parallel with the axis of rotation Ox in the vicinity of these fixed ends. A linkage section 23c that links the first deformation section 23a and the second deformation section 23b is arranged so as to surround the four corners of the coil holder 21.

A mirror 24 is fixed to mounting sections 21a in the middle on the front face side of the coil holder 21 by gluing its periphery, after locating its peripheral section in position thereon. The reflective surface 24a of the mirror 24 is constituted for example by gold, which has high reflectivity for light of wavelength for example 1.3 μm to 1.6 μm such as is used for optical communication, or by coating with a dielectric multi-layer film. The mirror 24 has a thickness of for example 0.625 mm, and is constructed by coating a semiconductor silicon wafer of the thickness that is employed as standard and cutting the external shape using a dicing saw. Since the thickness of a silicon wafer that is employed as standard is used without modification, this component can be obtained at extremely low cost. It would also be possible to make the thickness of the mirror any of the other standard thicknesses employed for silicon wafers, such as for example 0.525, 0.538 or 0.725 mm.

Mounting sections 21c as shown in FIG. 6 and FIG. 8 are formed in the middle on the rear face side of the coil holder 21. A mirror 25 as shown in FIG. 6 and FIG. 8 is fixed by adhesive on the mounting sections 21c, after locating the peripheral section of the mirror 25 in position thereon. The mirror 25 is employed for detecting tilting of the mirror 24. The mirror 25 is formed by a silicon wafer of thickness for example 0.2 mm, the reflecting face 25a thereof being formed by coating with gold, which has high reflectivity for light of wavelength for example 780 nm such as is used for the sensor.

A first coil 27 is arranged so as to surround the mirror 24 at the periphery of the mounting sections 21a of the coil holder 21. A second coil 28 is arranged so as to surround the mirror 25 at the periphery of the mounting sections 21c of the coil holder 21.

The middle of an arm 29 serving as a first support member formed of a substantially Q-shaped cross section is positioned by means of a stainless steel plate of thickness for example 0.1 mm in the space between the mirror 24 and the mirror 25, both ends 29a, 29a of the arm 29 being arranged to surround the periphery of the mirror 25 and fixed to the magnet holder 22. A conical projection 29b having a hole in the center thereof is formed in the center of the arm 29, being positioned so as to leave a clearance of for example 0.2 mm with respect to the rear face of the mirror 24, a substantially cylindrical-shaped or substantially drum-shaped pivot 31 being formed between the projection 29b and the mirror 24. The pivot 31 is formed by introducing between the projection 29b and mirror 24 a damping agent such as silicone rubber, silicone gel or oil, such as Taper X made by Cemedine Ltd or 3164 or 1220D made by Three Bond Ltd, curing this damping agent if curing is necessary using moisture, UV or heat. The pivot 31 is adjusted such that the axis of rotation Ox and Oy and the center of gravity G of the moveable section comprising the coil holder 21, first coil 27, second coil 28, mirror 24 and mirror 25 are positioned in the middle thereof.

First magnets 32, 32 for the first coil 27 magnetized as shown in FIG. 5 and FIG. 7 are adhesively fixed in an erect condition with the respective yokes 33, 33 thereof adhesively fixed at the rear face at the position of arrangement of the magnets on the front face of the magnet holder 22. Second magnets 34, 34 for the second coil 28 magnetized as shown in FIG. 6 and FIG. 7 are adhesively fixed in a transverse condition to the yokes 35, 35 thereof adhesively fixed at the rear face at the position of arrangement of the magnets on the rear face of the magnet holder 22.

Also, on the front face side of the optical deflector 11, a stopper 36 in the form of a rectangular frame is fixed by means of adhesive to the coil holder 21 on the front side of the first coil 27 as shown in the Figure in FIG. 5. Also, respective bosses 22a, . . . are formed at the four corners of the front face of the magnet holder 22 in the form of a rectangular frame, two T-shaped covers 37, 37 being fixed with reference to the upper bosses 22a, 22a and lower bosses 22a, 22a so as to be capable of abutment with the stopper 36. The stopper 36 and covers 37, 37 prevent excessive movement of the moveable unit including the mirror 24 when the mirror 24 is moved perpendicularly in the direction of the reflecting face 24a.

In the optical deflector 11, the coil holder 21, mirror 24, mirror 25, first coil 27 and second coil 28 constitute a moveable unit, the center of gravity G of this moveable unit being on the axes of rotation Ox, Oy as shown in FIG. 8. Also, an inertial main shaft S of the moveable unit is made to coincide with the axis of rotation Ox and axis of rotation Oy. The four springs 23, . . . are arranged so as to coincide with the plane including the axis of rotation Ox and axis of rotation Oy.

A first deformation section 23a is arranged in a position substantially coinciding with the axis of rotation Oy and a second deformation section 23b is arranged in a position substantially coinciding with the axis of rotation Ox. Furthermore, the first coil 27 is arranged in a position closer to the spring 23 than the second core of 28 is and the position of the center of gravity including the mirror 24 is thereby made to coincide with the axes of rotation Ox, Oy without a balancer.

Solder fixing portions 30, 30 and solder fixing portions 30, 30 are formed by the first deformation sections 23a, 23a causing a metal plate that passes through the interior of the coil holder 21 to project in the vicinity of the first deformation sections 23a, 23a. The terminals of both ends of the first coil 27 are connected with one of the pair of solder fixing portions 30, 30 by means of conductive adhesive or cream solder or arc welding or laser welding or laser soldering. Likewise, the terminals of both ends of the second coil 28 are connected with the other pair of solder fixing portions 30, 30 by means of conductive adhesive or cream solder or arc welding.

The end of the second deformation section 23b is inserted in the magnet holder 22 and this insertion portion is arranged within the magnet holder 22, being thereby linked to respective four connection terminals 38, 38, 38, 38.

In this way, by inserting and fixing one end of the four springs 23 in the coil holder 21 and the other ends thereof in the magnet holder 22, the coil holder 21 is moveably supported with respect to the magnet holder 22 by elastic deformation of the springs 23, resulting in bending deformation.

In this way, power can be supplied to the first coil 27 through the pair of springs 23, 23 and soldering portions 30, 30 from one pair of connecting terminals 38, 38. Likewise, power can be supplied through the pair of springs 23, 23 and soldering portions 30, 30 from the other pair of connecting terminals 38, 38 to the second coil 28.

In addition, two adjacent first deformation sections 23a and two adjacent second deformation section 23b are linked by dampers 39 constituted by respective UV-cured silicone gel; a construction is thereby obtained such that damping of the two ends of the spring 23 is achieved.

The optical deflector 11 is positioned in the housing 13 before being adhesively fixed. Thus, the optical deflector 11 is fixed to the housing 13 by the two bosses 22b, 22b formed at the rear face of the magnet holder 22 being fitted into two holes formed in a mounting face 13a of the housing 13. The housing 13 is die-cast of lead or die-cast of aluminum by using molding.

Next, the environs of the housing 13 of the optical deflection device 10 including the optical deflector 11 will be described. As shown in FIG. 4, a semiconductor laser 14, polarizing beam splitter 15, ¼ wavelength plate 16, condensing lens 17 and a semiconductor position detector 18 are mounted on the housing 13 and the tilt of the mirror can be detected by detecting the angle of tilt of the mirror 25.

The semiconductor laser 14 is installed in an aperture 13b of the housing 13. The ¼ wavelength plate 16 is bonded to one face of the polarizing beam splitter 15. Also, the polarizing beam splitter 15 is arranged and fixed at the middle of the housing 13. The condensing lens 17 is mounted in an aperture 13c formed in the center portion of the optical deflector mounting face 13a of housing 13. As shown in FIG. 4, the semiconductor position detector 18 is fixed to the housing 13 such that the photodetector unit 18a thereof faces the polarizing beam splitter 15. The optical deflector 11 is fixed to the optical deflector mounting face 13a of the housing 13.

The three connecting terminals of the semiconductor laser 14 are soldered to soldering portions 12b of the FPC 12. The package of the semiconductor laser 14 constitutes the cathode of the semiconductor laser 14 and is electrically connected with an external electrical circuit through the housing 13, which is formed of electrically conductive material. The semiconductor position detector 18 is also soldered onto the FPC 12. The semiconductor position detector 18 comprises a two-dimensional position sensor and this two-dimensional position sensor constitutes a sensor capable of outputting as a current the central position of the amount of light in two directions of the beam that is directed onto the photodetector unit 18a. For this two-dimensional position sensor, for example, the two dimensional position sensors “S5990-01” or “S7848-01”, of Hamamatsu Photonics Ltd may be used.

The FPC 12 incorporates a circuit for converting the current from the semiconductor position detector 18 to a voltage. Also, the FPC 12 incorporates a drive circuit that drives the first coil 27 and the second coil 28. The drive circuit is fixed abutting a spacer 19 that is fixed on the polarizing beam splitter 15 of the housing 13, the spacer 19 and the housing 13 being arranged to be capable of being in use as heat radiating members of the drive circuit.

A brief description of the operation of the optical deflection device 10 will now be given. When current is supplied to the first coil 27 through two springs 23, 23 of the four springs 23, 23, 23, 23, torque is generated in the moveable unit about the axis of rotation Oy caused by the action of the magnetic field of the first magnet 32, subjecting particularly the first deformation section 23a of the four springs 23 to torsional deformation and subjecting the pivot 31 to flexing deformation. The moveable unit is thereby tilted about the axis of rotation Oy.

When current is applied to the second coil 28 through the two springs 23, 23 of the four springs 23, 23, 23, 23, torque is generated caused by the action of the magnetic field of the second magnet 34 in the moveable unit about the axis of rotation Ox, subjecting particularly the second deformation section 23b of the four springs 23 to torsional deformation and subjecting the pivot 31 to flexing deformation. The moveable unit is thereby tilted about the axis of rotation Ox.

Also, the light from the semiconductor laser 14 with P polarization is incident onto the polarizing beam splitter 15, passes through the polarizing face 15a of the polarizing beam splitter 15 and is incident onto the reflecting face 25a of the mirror 25 through the ¼ wavelength plate 16 and condensing lens 17. The light that is reflected at the reflecting face 25a is incident onto the polarizing beam splitter 15 through the condensing lens 17 and ¼ wavelength plate 16. The light that is incident onto the polarizing beam splitter 15 has then passed therethrough a total of two times along the outgoing path and return path and its plane of polarization is thereby rotated through 90° to produce S polarization; it is thus reflected at the polarizing face 15a of the polarizing beam splitter 15 and is hence incident onto the photodetector unit 18a of the semiconductor position detector 18.

When the mirror 24 (mirror 25) is tilted about the axis of rotation Oy with current conducted to the first coil 27, light that is input to the photodetector unit 18a of the semiconductor position detector 18 is moved in the X′ axis direction shown in FIG. 4 on the photodetector section 18a of the semiconductor position detector 18. Likewise, when the mirror 24 (mirror 25) is tilted about the axis of rotation Ox with current conducted to the second coil 28, this light is moved in the Y′ direction shown in FIG. 4 on the photodetector unit 18a of the semiconductor position detector 18. Tilting of the mirror 24 in two directions can therefore be detected from the output of the semiconductor position detector 18.

With a support device for an optical element as described above, the following benefits are obtained.

(1) The moveable unit including for example the mirror 24, mirror 25 and coil holder 21 is supported on the fixing unit (magnet holder 22) tiltably about axes of rotation Ox and Oy, that intersect orthogonally, by positioning the center of the arm 29 constituting a first support member in the space between the mirror 24 and mirror 25, arranging the two ends 29a, 29a of the arm 29 so as to surround the periphery of the mirror 25, and adhesively fixing this to the magnet holder 22 and coupling the center of the arm 29 to the rear face of the mirror 24 through the pivot 31. The arm 29 and pivot 31 therefore cannot interfere with the outgoing and incident beam directed onto the mirror 24 or mirror 25.

(2) The pivot 31 is made into substantially cylindrical shape or drum shape, and is formed so as to extend in the direction perpendicular with respect to the reflecting face 24a of the mirror 24 and the reflecting face 25a of the mirror 25. The rigidity of the pivot 31 in the perpendicular direction therefore can be made high and the rigidity of the moveable unit in the perpendicular direction can thus be made very much higher. For example, whereas, if the moveable unit is supported only by the springs 23 constituting the second support members, the resonant frequency of the moveable unit in this perpendicular direction is about 80 Hz, addition of the arm 29 constituting a first support member that provides support by coupling with the pivot 31 enables the resonant frequency of the moveable unit to be improved to about 400 Hz.

(3) The pivot 31 is positioned in the vicinity of the center of rotation of the moveable unit. The increase in rigidity when the moveable unit is tilted therefore can be reduced, making it possible to reduce the drop in drive sensitivity on tilting and making it possible to minimize deformation of the pivot 31 when the moveable unit is tilted and thereby making it possible to prevent pressure damage to the pivot 31.

(4) The arm 29 that supports the moveable unit by means of the pivot 31 is arranged in the space between the mirror 25 and the coil holder 21 so as to be surrounded thereby. It is therefore unnecessary to form a deep slit or the like for the arrangement of the arm 29 in the coil holder 21, lower the rigidity of the coil holder 21, or interfere with the springs 23.

(5) The first coil 27 and second coil 28 that are driven bi-directionally and integrally support the mirror 24 and mirror 25 on the coil holder 21 are arranged so as to clamp the springs 23 that tiltably support the coil holder 21 including the center of rotation in the above two directions of the coil holder 21. There is therefore no possibility of the center of drive torque produced by the first coil 27 and second coil 28 becoming markedly offset from the center of rotation. Also, since the position of the center of gravity of the first coil 27 and second coil 28 can easily be made to coincide with the center of rotation, the production of undesirable resonance when the mirror 24 and a mirror 25 are driven so as to produce tilting can be suppressed, enabling an excellent servo characteristic to be obtained.

(6) Dampers 39 are provided at both ends of the springs 23. Vibration of the springs 23 therefore can be effectively suppressed. Since the semiconductor position detector 18 that detects tilting of the mirror 24 is arranged on the rear face side of the reflective face 24a of the mirror 24, there is no possibility of the semiconductor position detector 18 interfering with the principal rays deflected by the mirror 24.

### First Embodiment of the Present Invention

A method of manufacturing a support device for an optical element according to an embodiment of the present invention is described below with reference to FIG. 2 to FIG. 9 and FIG. 10 to FIG. 13.

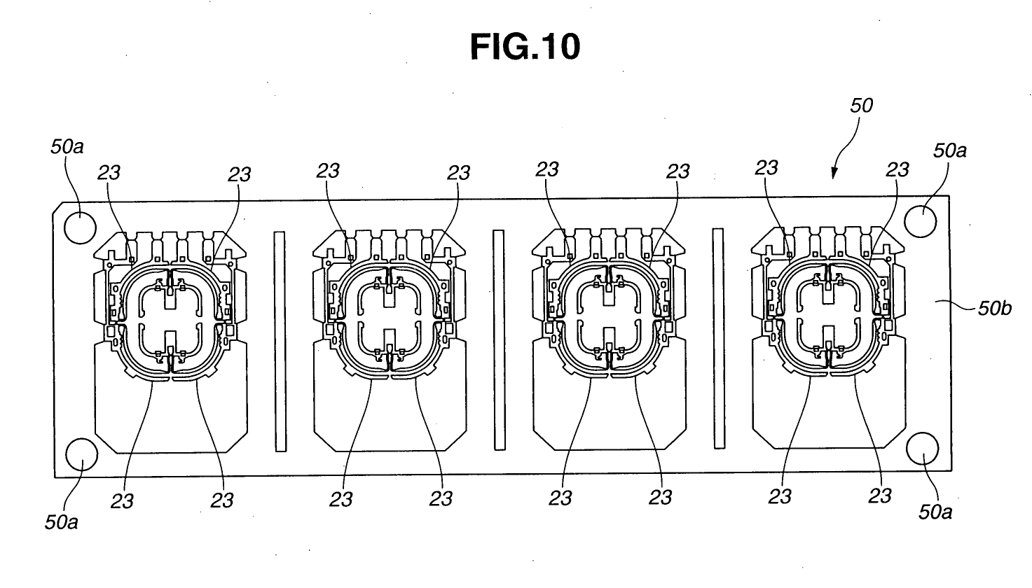

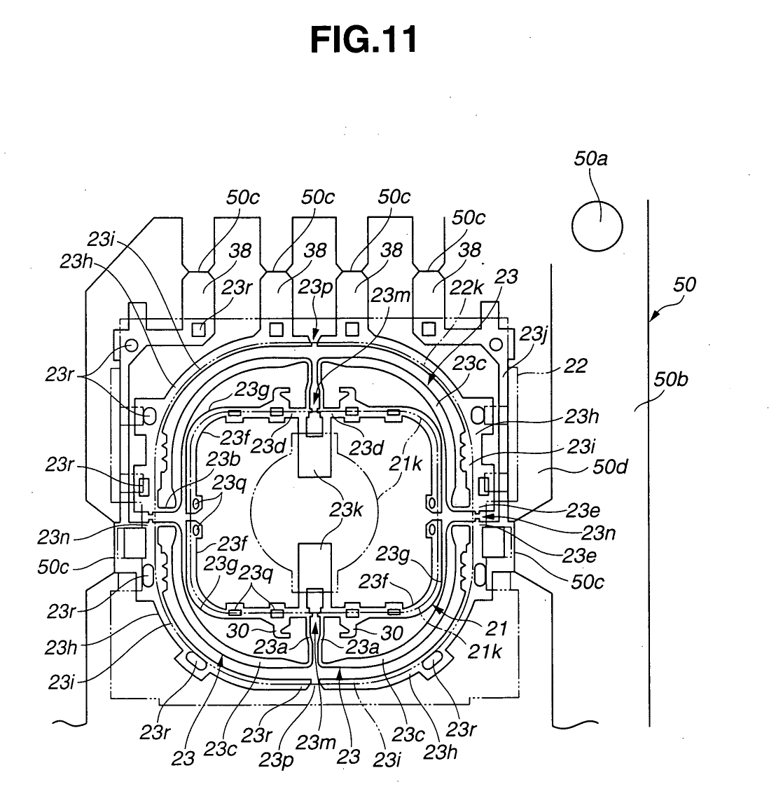

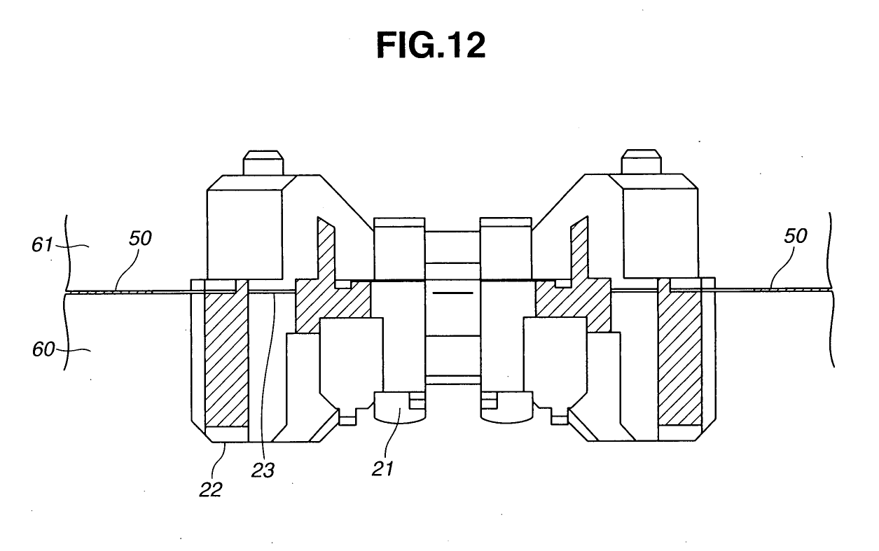

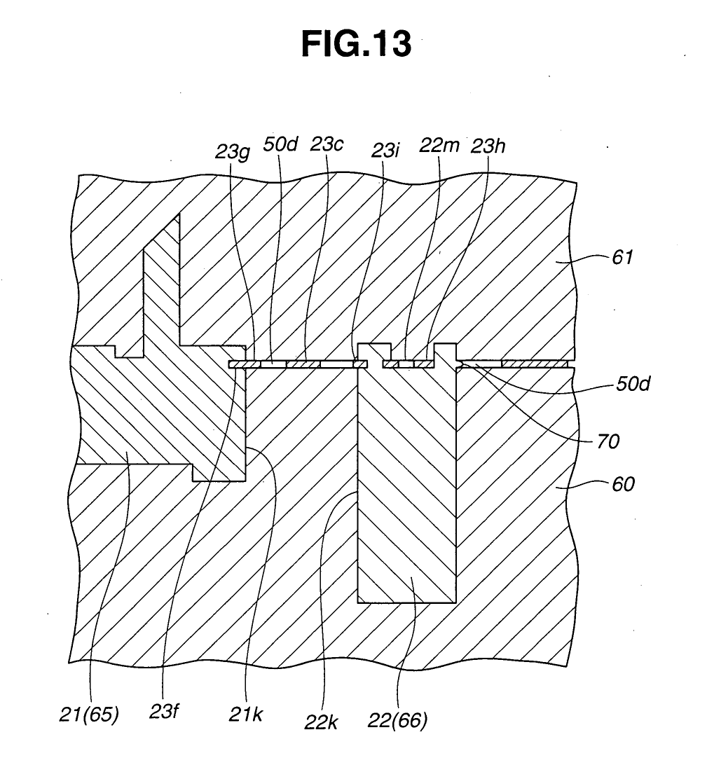

FIG. 10 is a plan view showing a spring sheet employed in a method of manufacturing a support device for an optical element according to an embodiment of the present invention. FIG. 11 is a view showing to a larger scale a single spring body of the spring sheet employed in the method of manufacturing a support device for an optical element according to an embodiment of the present invention. FIG. 12 is a view showing a metal mold used in a method of manufacturing a support device for an optical element according to an embodiment of the present invention. FIG. 13 is a sectional view showing to a larger scale part of a metal mold used in the method of manufacturing a support device for an optical element according to an embodiment of the present invention.

This method of manufacturing a support device for an optical element is a method whereby it is possible to ensure that flash or the like is not generated, by making the shape of the spring 23 a special shape, keeping the fixed metal mold and moveable metal mold flat without forming for example recesses matching the shape of the spring 23 in the fixed metal mold and moveable metal mold, and creating reliable adhesion of the fixed mold and moveable mold and spring 23 by insertion molding while holding the fixed mold, the moveable mold and the spring 23 maintaining a clearance of the thickness of the spring 23.

According to this method of manufacturing a support device for an optical element, in outline, a support device for an optical element is manufactured by the following steps.

A spring sheet 50 for manufacturing the required number of shapes shown in FIG. 10 and FIG. 11 is manufactured (first step). As will be described in detail later, four springs 23, 23, 23, 23 are formed as shown in FIG. 10 in the spring sheet 50.

Next, the spring sheet 50 is aligned (second step) with a positioning member of a fixed metal mold 60 that is set in position on an upright molding member adapted for insertion molding, using positioning holes 50a (pilot holes) of this spring sheet, as shown in FIG. 12 and FIG. 13. The details are described below.

At the point where the spring sheet 50 is thus positionally located, insertion molding is performed (third step), for the coil holder 21 constituting the moveable unit and the magnet holder 22 constituting the fixing unit, by pouring non-conductive plastic into a moveable unit forming recess 65 and fixing unit forming recess 66 formed in the moveable metal mold 61 and the fixed metal mold 60, after mating the mating face of the moveable metal mold 61 with the mating face of the fixed metal mold 60 and while maintaining the mating faces of these two with a clearance of the thickness of the springs 23. The details are described below.

After completion of insertion molding, separation is effected at a prescribed separating section (fourth step).

After this, the second step to the fourth step described above are repeated the requisite number of times.

Next, the shape of the springs 23, which are made of special shape, will be described below.

The spring sheet 50 is formed with four springs 23, 23, 23, 23 and four pilot holes 50a, by etching processing or press processing of foil, for example made of beryllium copper, of thickness 20 μm. Employing such a spring sheet 50 makes it possible to form four moveable units (coil holders 21) and fixing units (magnet holders 22) during insertion molding.

As shown in FIG. 10, the spring sheet 50 is formed in a framed-shaped body 50b; the spring sheet 50 and the springs 23 are linked and constitute connecting sections 50c which link portions constituting connecting terminals 38 and the frame-shaped body 50b at the other four peripheral portions of the springs 23, the connecting sections 50c being constituted by half etching or with sewing machine holes constituting a large number of small holes. In this way, separation can easily be effected at the connecting sections 50c after molding.

As shown in FIG. 11, the springs 23 are constituted respectively by a spring member formed with a spring linkage section 23c formed in a shape enclosing a prescribed length of the periphery of the coil holder 21, constituting the moveable unit, and portions constituting deformation sections 23a, 23b at both ends of the spring linkage section 23c and are formed in a shape so as to substantially surround the entire periphery of the moveable unit and the fixing unit by means of: extensions 23f and a projection 23g, which are formed on ends 23d of the moveable unit formed of a prescribed length along the peripheral side of the moveable unit (coil holder 21), constituting an insertion molded portion, on the moveable unit (coil holder 21) and formed at one end of the spring member (tip of the first deformation section 23a); and extensions 23h and a projection 23i, which are formed on ends 23e of the fixing unit formed of a prescribed length along the inner circumference of the fixing unit (magnet holder 22), constituting an insertion molded portion on the fixing unit (magnet holder 22) and formed at the other end of the spring member (tip of the second deformation section 23b).

Furthermore, as shown in FIG. 11, ends 23d of the moveable unit constituting a member at one end of the spring 23 are provided with extensions 23f constituting another part in a condition inserted when molding the moveable unit 21 and formed with a prescribed length along the periphery 21k on the peripheral side of the moveable unit (coil holder 21), and with four projections 23g constituting a part that is exposed when the moveable unit 21 is molded and that projects by a prescribed length outside of the periphery 21k of the moveable unit (coil holder 21), being integrally formed with the extensions 23f. The extensions 23f and projections 23g are formed in a shape substantially surrounded by the entire periphery of the moveable unit (coil holder 21). A solder fixing portion 30 is formed on each extension 23f.

Also, as shown in FIG. 11, the ends 23e of the fixing unit of the spring 23 are provided with extensions 23h constituting another part in a condition inserted when molding the fixing unit 22 and formed with a prescribed length along the inner circumference 22k on the inner circumferential side of the fixing unit (magnet holder 22), being a portion that is insertion molded in the fixing unit (magnet holder 22); and with four projections 23i constituting a part that is exposed when the fixing unit 22 is molded and that projects by a prescribed length inwards from the inner circumference 22k, being integrally formed with the extensions 23h. The extensions 23h and projections 23i are formed in a shape substantially surrounded by the front inner circumference of the fixing unit (magnet holder 22). It should be noted that, as shown in FIG. 11, the ends 23e of the fixing unit may be of a shape in which the connecting terminals 38, 38 are directly connected to the two extensions 23h or may be of a shape in which the connecting terminals 38, 38 are connected with the two extensions 23h through connecting bodies 23j.

Furthermore, as shown in FIG. 11, a linking section 23k is provided on the side of the respective first deformation section 23a of the ends 23d on the side of the moveable unit, the linking section 23k being formed such that it can be cut off after molding. As shown in FIG. 11, the ends 23d on the side of the moveable unit are provided with clearances 23m of about 0.03 to 0.2 mm such that they can be electrically isolated after molding. As shown in FIG. 11, through-holes 23q are formed in prescribed positions on the ends 23d on the side of the moveable unit.

In addition, as shown in FIG. 11, the ends 23e on the side of the fixing unit are provided with clearances 23n, 23p of about 0.03 to 0.2 mm so that they can be electrically isolated after molding. As shown in FIG. 11, through-holes 23r are formed in prescribed positions on the ends 23e on the side of the moveable unit.

The spring sheet 50 shaped in this way is held on the fixed metal mold 60 of the upright molding machine using the pilot holes 50a as reference and is clamped by the moveable metal mold 61 with a clearance of the thickness of the spring sheet 50. The springs 23 of the spring sheet 50 are then insertion molded in a condition linked by linking sections 23k, so positioning and holding of the springs 23 on the side of the coil holder 21 during insertion molding is facilitated, making it possible to achieve more precise insertion molding in the coil holder 21.

Also, as shown in FIG. 9 and FIG. 13, on the moveable metal mold 61, at the inside of the coil holder 21 and magnet holder 22, one face of the spring 23 is arranged to be directly subjected to pressure from a portion of the moveable metal mold 61, so that, after molding, a recess 21m in which no resin is present is formed in part of the coil holder 21 and a recess 22m in which no resin is present is formed in part of the magnet holder 22.

Also, both the mating face of the fixed metal mold 60 and the mating face of the moveable metal mold 61 employed in the method of manufacturing a support device for an optical element according to this embodiment and of the present invention are planar, with no projections, relief, or recesses corresponding to the portion 50d where the spring sheet 50 does not exist at all.

When the fixed metal mold 60 and moveable metal mold 61 are brought together with the spring sheet 50 being clamped by the fixed metal mold 60 and moveable metal mold 61, the projections 23g of the ends 23d on the side of the moveable unit and the projections 23i of the ends 23e on the side of the fixing unit are clamped by the fixed metal mold 60 and moveable metal mold 61 and the projections 23g and projections 23i are positioned on the parting line defined by the mating faces of the fixed metal mold 60 and moveable metal mold 61, so no clearance can be generated on the side of the parting line from the molding recess 65 of the moveable unit (coil holder 21) and the molding recess 66 of the fixing unit (magnet holder 22).

At the point where such a condition is produced, non-conductive plastic such as liquid-crystal polymer containing for example titanate whiskers or liquid-crystal polymer containing glass fiber is poured into the molding recess 65 of the moveable unit and the molding recess 66 of the fixing unit. At this point, flow of the non-conductive plastic to the front and rear of the springs 23 is facilitated by the through-holes 23q provided in the ends 23d on the side of the moveable unit and the through-holes 23r provided in the ends 23 on the side of the fixing unit, so firmer fixing can be achieved of the ends 23d on the side of the moveable unit and the ends 23e on the side of the fixing unit by inflow of resin into the through-holes 23q and through-holes 23r.

After molding, support devices for an optical element can be obtained by removing the moveable metal mold 61 and extracting the support device for the optical element, cutting the spring sheet 50 at the connecting sections 50c and also cutting off the linking sections 23k.

Since in this way the springs 23 of the spring sheet 50 are constituted in a shape blocking the parting line of the molding recess 65 of the moveable unit and molding recess 66 of the fixing unit, formation of flash by flow of the resin from the parting line is eliminated, since no complicated relief or recesses are provided in the fixed metal mold 60 or moveable metal mold 61.

It should be noted that a clearance constituting a space of the thickness 20 μm of the spring sheet 50 is produced at the periphery of the magnet holder 22, since, as shown in FIG. 13, springs 23 of the spring sheet 50 are there absent. Flash 70 is therefore generated from the side of the magnet holder 22, through the clearance on the parting line on the peripheral side of the magnet holder 22. The production of such flash can be kept to a low level by ensuring that rapid solidification occurs, by adjusting the amount of heating and by employing liquid-crystal polymer containing titanate whiskers or liquid-crystal polymer containing glass fiber.

Such liquid-crystal polymers have a broader melting point than liquid-crystal polymers such as PPS and are very easily solidified or melted, with an amount of heat on solidification of no more than 1/10. The production of flash is suppressed in embodiments of the present invention by effectively utilizing their property of a large dependence of the rate of shearing on molten viscosity and their property of melting/solidifying with exchange of only a very small amount of heat.

It has been established by tests that only minute amounts of flash are generated so long as the thickness of the springs 23 is no more than 30 μm.

It should be noted that in cases such as the periphery of the magnet holder 22, where springs 23 are not present and molding can be easily achieved since the mold processing is not of high precision, the clearance at the parting line can be eliminated by mold processing or may be suitably selected at the various portions depending for example on the shape of the molding, the allowed amount of flash and ease of mold processing.

Also, although in the present embodiment both ends of the respective springs were inserted in the magnet holder and coil holder, the present embodiment would of course still be applicable even in the case where only one end is insertion molded. In this case, the end that is not inserted could be fixed to the spring by gluing or other method but it would also be possible to form for example the coil holder by means of the spring itself.

With this embodiment of the present invention, the following benefits can be obtained.

(1) By employing a liquid-crystal polymer as the resin for insertion molding of the thin plate-type springs 23 and by making the thickness of the springs 23 no more than 30 μm, it can be ensured that even if a clearance of the spring thickness is produced at the parting line of the fixed metal mold 60 and moveable metal mold 61, very little flash is produced therefrom.

(2) Also, mold processing is facilitated by the fact that complicated processing such as for complicated projections or relief in the fixed metal mold 60 and moveable metal mold 61 is unnecessary. Since there is no variability due to processing errors caused by for example projections or relief of the metal molds, reliable clamping of the springs 23 at the parting line of the metal molds can be achieved. Furthermore, since there are no projections or relief or the like in the metal molds corresponding to the springs 23, even if the shape of the springs 23 is altered, such alteration of the springs 23 can easily be coped with.

(3) Also, since the springs 23 are provided with projections 23g and projections 23i projecting so as to surround not only of the vicinity of the fixed edges on the side of the coil holder 21 of the spring 23 and the vicinity of the fixed edges on the side of the magnet holder 22 but also the periphery of the portion where the resin is molded, and the projections 23g and projections 23i are arranged to be clamped by the metal molds (60, 61), even though no projections or relief or the like are provided on the metal molds (60, 61), a portion of the springs 23 is arranged at the parting line, leakage of resin at the parting line from the support device for the optical element is blocked, preventing flash from being produced. Also, stable molding can be performed since the projections 23g and projections 23i of the springs 23 are clamped by the metal molds (60, 61), the springs 23 are held in a stabilized position in the interior of the resin with no possibility of the springs being shifted within the metal molds (60, 61) when the resin is extruded.

(4) Furthermore, high rigidity of the molded product is achieved since the extension 23f of the spring 23 is positioned within the coil holder 21 and the extension 23h of the spring 23 is positioned within the magnet holder 22, respectively, that is, the resin product is reinforced by a member with smaller thermal expansion than in the case of resin and with high rigidity.

(5) Since the moveable unit is manufactured so as to be supported on the fixing unit by four springs 23 arranged so as to surround its periphery, supply of power to the first coil 27 and second coil 28 can be performed by means of the four springs 23, so a flexible cable becomes unnecessary, making it possible to reduce the number of components and ensuring that there is no effect on the support and drive action of the moveable unit.

(6) Since the moveable unit is insertion molded so as to be supported on the fixing unit by four springs 23 arranged so as to surround its periphery, mutual contact of the four springs 23 can be prevented and positioning of the springs 23 facilitated.

Since the four springs 23 can be set in the metal mold integrally with a single spring sheet at the connecting sections 50c, mounting of the springs is easily achieved and high mutual positional accuracy of the four springs and high accuracy of the four coil springs with respect to the coil holder and magnet holder are achieved.

The two springs are connected together at respective one ends thereof by providing the linking section 23k, and hence the ends of the springs on the coil holder side are allowed to have a higher rigidity and to be set in the metal mold with a higher positional accuracy.

Also, since connection elements 38 are provided on the magnet holder 22, electrical connection with the springs 23 is facilitated.

### Second Embodiment of the Present Invention

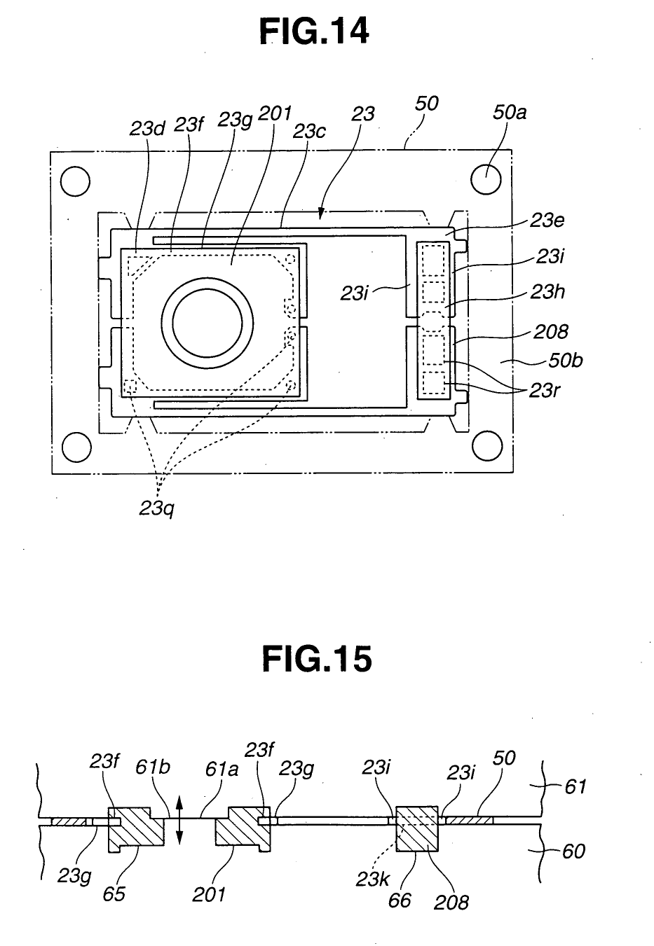

The second embodiment of the present invention is an example of the case where the invention is applied to a support device for an objective lens employed in an optical pickup as illustrated in the description section of the prior art. The second embodiment of the present invention applied to manufacture of a support device for an objective lens is described with reference to FIG. 14 to FIG. 16.

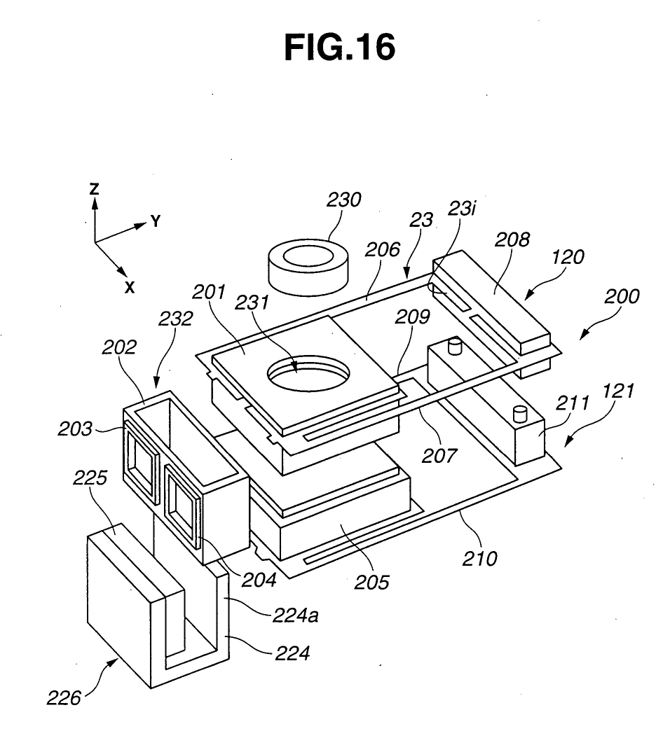

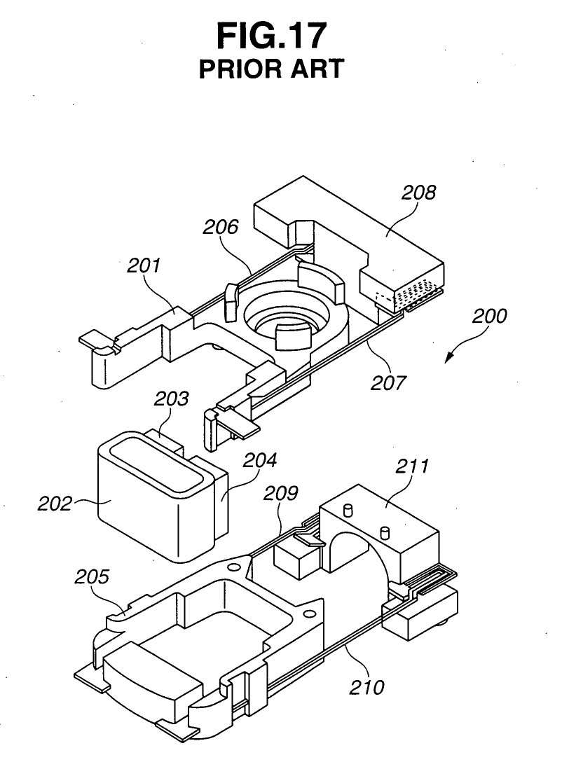

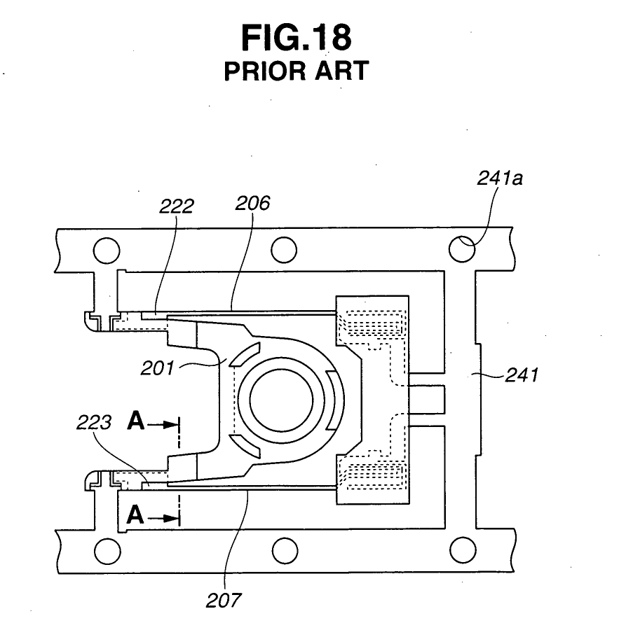

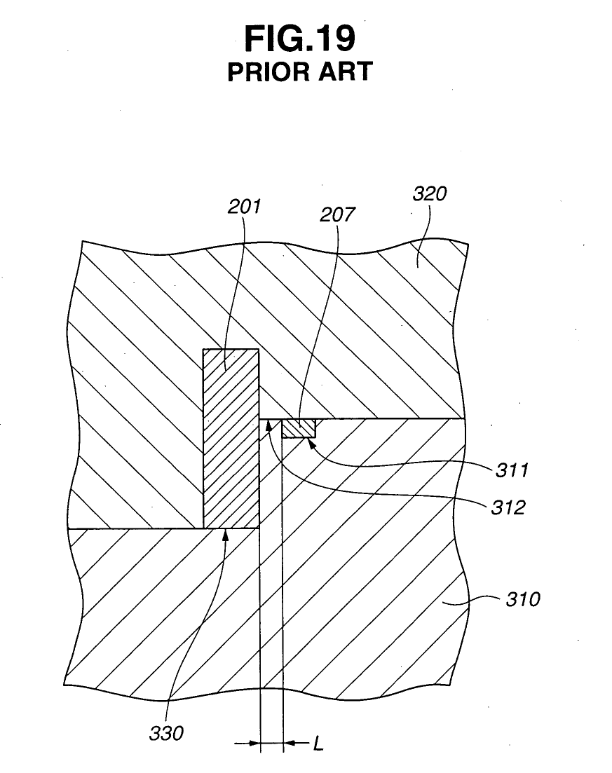

FIG. 14 is a plan view given in explanation of a method of manufacturing a support device for an optical element according to a second embodiment of the present invention. FIG. 15 is a sectional view given in explanation of a method of manufacturing a support device for an optical element according to a second embodiment of the present invention. FIG. 16 is an exploded perspective view showing a support device for an objective lens manufactured by a method of manufacturing a support device for an optical element according to a second embodiment of the present invention.

In the second embodiment of the present invention, members which are the same as in the case of the first embodiment or the prior art objective lens support device are described by giving them the same reference symbols.

In the second embodiment of the present invention also, a spring sheet 50 forms springs 23 of special shape as shown in FIG. 14 and FIG. 15 in stainless steel foil of sheet thickness 15 μm.

A moveable bobbin 201 and a fixed bobbin 208 are molded by extruding non-conductive resin into the interior of a holding unit molding recess 65 and fixing unit molding recess 66 formed by mating a fixed metal mold 60 and a moveable metal mold 61 with the spring sheet 50 clamped by the fixed metal mold 60 and moveable metal mold 61.

In the spring sheet 50, the ends 23d of the moveable unit extend so as to surround the periphery of the moveable bobbin 201 and the ends 23e of the fixing unit extend so as to surround the periphery of the fixed bobbin 208.

The ends 23d of the moveable unit comprise an extension 23f embedded in the moveable bobbin 201 and that extends so as to surround the periphery of the moveable bobbin 201, and an extension 23g that extends and projects so as to surround the periphery thereof and is integrally formed with the extension 23f.

Also, the ends 23e of the fixing unit comprise an extension 23h embedded in the fixed bobbin 208 and that extends so as to surround the periphery of the fixed bobbin 208, and an extension 23i that extends and projects so as to surround the periphery thereof and is integrally formed with the extension 23h.

It should be noted that, as shown in FIG. 14, through-holes 23q are provided in the ends 23d of the moveable unit and through-holes 23r are provided in the ends 23e of the fixing unit just as in the case of the first embodiment.

The spring sheet 50 is positioned in the fixed metal mold 60 by pilot holes 50a so that the springs 23 of the spring sheet 50 are clamped between the moveable metal mold 61 and fixed metal mold 60; non-conductive resin is extruded into the holding unit forming recess 65 and fixing unit forming recess 66 while holding the moveable metal mold 61 and fixed metal mold 60 with a separation equal to the thickness of the springs 23. In this way, an upper molding 120 as shown in FIG. 16 is manufactured. Production of flash can be prevented since leakage of resin at the parting line is prevented by clamping of the projections 23g and projections 23i of the spring sheet 50 between the fixed metal mold 60 and the moveable metal mold 61. Flash from the portions in the parting line where the projections 23g and projections 23i are absent can also be reduced to a very small amount since the clearance between the fixed metal mold 60 and moveable metal mold 61 i.e. the thickness of the spring is very small, at 15 μm, and since the use of a liquid-crystal polymer makes it difficult for flash to escape.

Also, as shown in FIG. 16, the upper molding 120 and lower molding 121 are formed substantially in the same way. The upper molding 120 and lower molding 121 constitute the support device 200 for an optical element when glued and fixed together in a vertically superimposed manner.

It should be noted that the first moveable bobbin 201 holds the objective lens 230, so an aperture 231 for insertion of the objective lens 230 is provided in the first moveable bobbin 201. As shown in FIG. 16, drive coils 232 comprising a focusing coil 202 and tracking coils 203, 204 are glued on both side faces of the first moveable bobbin 201 and second moveable bobbin 205. Only one drive coil 232 is shown in FIG. 16.

The focusing coil 202 and tracking coils 203, 204 are inserted in an internal yoke 224a of members 226, wherein a magnet 225 is fixed in a yoke 224 that is attached to a base, not shown, formed in U-shape.

The first fixed bobbin 208 supports the first moveable bobbin 201 by means of suspensions 206, 207 that are constituted of springs 23. The first fixed bobbin 208 constitutes the upper molding 120.

The second fixed bobbin 211 supports the second moveable bobbin 205 by means of suspensions 209, 210. The second fixed bobbin 211 constitutes the lower molding 121.

With the above construction, the first moveable bobbin 201 and the second moveable bobbin 205 are moved in parallel with the z direction or x direction of FIG. 16 with respect to the first fixed bobbin 208 and the second fixed bobbin 211 by passing current in the focusing coil 202 or tracking coils 203, 204 through the springs 23. Elastic deformation of the suspensions 206, 207, 209, 210 then occurs.

It should be noted that, as shown in FIG. 15, a projection 61a is formed in the moveable metal mold 61 such that an aperture 221 where the lens 220 is inserted is formed and then a parting line 61b is formed in the moveable metal mold 61. Thus, if the metal molds are subjected to processing such that the mating faces of the fixed metal mold 60 and moveable metal mold 61 are in close contact in portions where the projections 23g and projections 23i of the springs 23 are not provided, no resin can flow from the parting line 61b and generation of flash can thereby be prevented. The absence of the fine springs from the parting line 61b means that the shape of the metal molds remains uncomplicated.

Also, in this case, since substantially the entire periphery of the parting line of the molding is constituted of a spring projection or mating face where the metal molds are in close contact, generation of flash at the parting line when other materials such as PPS or polycarbonate, which are more liable to flash, are employed can be prevented.

The second embodiment of the present invention presents the same beneficial effects as the first embodiment.

### MODIFIED EXAMPLES

The present invention is not restricted to the first embodiment and second embodiment described above and various modifications or alterations are possible. For example, whereas, in the first embodiment, the mirror 24 is constructed as a tilting device, it is possible to employ a prism or lens instead of this mirror 24, or to employ a photoreceiving element, such as a photodetector, a light emitting element such as LED or laser, or composite optical element comprising a combination of these.

In the above embodiments, beryllium copper of sheet thickness 20 μm is employed for the springs 23 but, if it is arranged for the projections 23g and projections 23i of the springs 23 to project at the periphery of the molding and for these portions to be clamped by the metal molds (60, 61) so that no clearance is present from the molding side of the parting line, the thickness of the springs 23 could be increased. In this case, the amount of flash appearing at the clearance 23m, clearance 23n and 23p can be reduced by making the clearance 23m, clearance 23n and 23p of the springs 23 preferably narrower at no more than 30 μm. Also, if the springs 23 are made no thicker than 30 μm and a minute amount of flash is permitted, it is not necessarily essential to provide extensions 23f, extensions 23h, projections 23g or projections 23i.

Also, in the above embodiments, since the metal springs 23 are used to supply power to the first coil 27 and second coil 28, the extensions 23f and extensions 23h have to be electrically insulated. However, if there is no need for electrical isolation, or if a conductive pattern for supply of power is formed in polyimide film, there is no need to make the extensions 23f and extensions 23h electrically independent, so the periphery or inner circumference of the molding can be allowed to project so as to completely surround the projections 23g and projections 23i.

Also, the projection 23g or projection 23i projecting at the periphery of the outer or inner circumference of the molded product need not be continuous with the linking section 23c of the springs 23 and the projection 23g or projection 23i could be separated from the linking section 23c after forming, by providing the linking section 23k.

Furthermore, apart from beryllium copper, the spring sheet 50 could be any thin sheet material capable of supporting the moveable unit in moveable fashion, such as other types of metal foil such as thin stainless-steel foil or phosphor bronze foil, or resin film such as a polyimide film or PET film, an etched silicon wafer sheet or piezoelectric element sheet.

Also, substantially the entire periphery of the molding may be surrounded by springs. Also, in cases where the thickness of the springs is extremely small, for example no more than 20 μm, or where the allowed amount of flash appearing at the parting line is large, other resins excepting liquid-crystal polymers, such as for example polycarbonate, polyether sulfone, or polyphenylene sulfide may be employed. Being not restricted to these, a suitable selection may be made of resins and additives such as fillers included in these resins.

In addition, the method of manufacturing a support device for an optical element according to the present invention is not restricted to manufacture of optical deflection devices employed for changeover of optical paths for optical communication and could be effectively employed for manufacture of support/drive devices for optical deflection devices employed for example in measuring instruments or pickups for optical recording/reproduction, or lenses.

As described above, by employing a spring body formed in a shape surrounding substantially the entire periphery of the fixing unit and the moveable unit by means of a spring portion formed in a shape surrounding a prescribed length of the periphery of a moveable unit, an end on the side of the moveable unit formed in a prescribed length along the periphery of the moveable unit, being a portion that is insertion molded in the moveable unit and formed at one end of the spring portion, and an end on the side of the fixing unit formed in a prescribed length along the inner circumferential side of the fixing unit, being a portion that is insertion molded in the fixing unit and formed at the other end of the spring portion and
insertion molding of the spring body clamped by planar faces of the fixed metal mold and moveable metal mold, with a clearance of the thickness of the spring body formed therebetween, the following benefits are obtained.

Complicated processing such as of complicated projections or relief in the portions of the fixed metal mold and moveable metal mold that clamp the spring body is unnecessary, facilitating processing of the metal molds. Since there is therefore no variability produced by processing errors of projections or relief or the like of the metal molds, a spring body can be reliably clamped at the parting line of the metal molds. Furthermore, even if the shape of the spring body is altered, owing to the absence of projections or relief or the like corresponding to the spring body from the metal molds, alteration of the spring body can easily be coped with. By employing a liquid-crystal polymer as the resin of the insertion molding of the thin plate-type spring body or by making the thickness of the spring body no more than 30 μm, generation of flash therefrom can be reduced to a minute amount even if a clearance, of the amount of the spring thickness, is produced at the parting line of the fixed metal mold and moveable metal mold.

Also, since the spring body is provided with projections projecting so as to surround the periphery of the portion where resin molding is effected and these projections are clamped by the metal molds, even though projections or relief or the like are not provided on the metal molds, the fact that part of the spring body is arranged on the parting line results in blocking of resin leakage at the parting line from the support device for the optical element and thereby makes it possible to prevent flash being generated. Also, since the projections of the spring body are clamped by the metal molds, when the resin is extruded, the spring body does not move within the metal molds, making it possible to maintain a stable position thereof in the interior of the resin and to perform molding in a stable fashion.

It is clear that, according to the present invention, different embodiments in a wide range can be constituted according to the present invention without departing from the spirit and scope of the invention. The present invention is not therefore restricted by the specific embodiments otherwise than as defined by the appended claims.

1. A support device for an optical element comprising:
a holder having at least an optical element; and
a fixing unit that supports the holder moveably in at least one direction by means of a thin plate-type spring;
wherein the support device further comprises a first insertion molding portion in which the holder is insertion molded in a condition with a first portion of the spring inserted into the holder molding portion and/or a second insertion molding portion in which the fixing unit is insertion molded in a condition with a second portion of the spring inserted in the fixing unit molding portion; and
the thickness of the spring forms a clearance space of mating faces of a metal mold forming the holder and/or the fixing unit at least in the vicinity of the spring.

2. The support device for the optical element according to claim 1 wherein the holder and/or the fixing unit are formed of resin containing liquid-crystal polymer.

3. The support device for the optical element according to claim 1 wherein the thickness of the spring is no more than 30 μm.

4. A method of manufacturing a support device for an optical element comprising at least:
a step comprising a first insertion step in which at least a part of a first end of a thin plate-type spring that moveably supports in at least one direction with respect to a fixing unit a holder having at least one optical element is exposed while another part of the first end is inserted into the holder during molding of the holder; and/or a second insertion step in which a part of a second end of the spring is exposed while another part of the second end is inserted into the fixing unit during molding of the fixing unit;
a step of positioning the spring in a first metal mold; and
a step of insertion molding the holder and/or the fixing unit by mating a second metal mold and the first metal mold at least partially other than the first end or the second end of the side walls of the holder or of the fixing unit, providing a clearance corresponding to the thickness of the spring, and injecting plastics into the holder forming portion and/or the fixing unit forming portion formed when the two metal molds are thus united.

5. A manufacturing device for manufacturing a support device for an optical element comprising at least:
a first insertion molding portion in which at least a part of a first end of a thin plate-type spring that moveably supports in at least one direction with respect to a fixing unit a holder having at least one optical element is exposed while another part of the first end is inserted into the holder during molding of the holder; and/or a second insertion molding portion in which a part of a second end of the spring is exposed while another part of the second end is inserted into the fixing unit during molding of the fixing unit;
a positioning section that positions the spring in the first metal mold; and
insertion molding means for insertion molding the holder and/or the fixing unit by mating a second metal mold and the first metal mold at least partially other than the first end or the second end of the side walls of the holder or of the fixing unit, providing a clearance corresponding to the thickness of the spring, and injecting plastics into the first insertion molding portion and/or the second insertion molding portion formed when the two metal molds are thus united.

6. A manufacturing device for manufacturing a support device for an optical element comprising at least:
a first insertion molding portion in which at least a part of a first end of a thin plate-type spring that moveably supports in at least one direction with respect to a fixing unit a holder having at least one optical element is exposed while another part of the first end is inserted into the holder during molding of the holder; and/or a second insertion molding portion in which a part of a second end of the spring is exposed while another part of the second end is inserted into the fixing unit during molding of the fixing unit;
a positioning section that positions the spring in the first metal mold; and
insertion molding means for insertion molding of the holder and/or the fixing unit by mating a second metal mold and the first metal mold at least partially other than the first end or the second end of the side walls of the holder or of the fixing unit by the spring, and injecting plastics into the first insertion molding portion and/or the second insertion molding portion formed when the two metal molds are thus united.

7. The support device for an optical element according to claim 1 wherein the spring comprises a projection that projects from the side wall of the holder and/or the side wall of the fixing unit, in at least part other than the first portion of the holder and/or in at least part other than the second portion of the fixing unit.

8. The support device for an optical element according to claim 7 wherein the projection projects from substantially the entire periphery of the side wall of the holder and/or substantially the entire periphery of the side wall of the fixing unit.

9. The support device for an optical element according to claim 7 wherein the spring comprises a linking section that links the holder and the fixing unit and the linking section is separated from the projection.

10. The support device for an optical element according to claim 1 wherein the spring comprises a linking section that links the holder and the fixing unit.

11. The support device for an optical element according to claim 1 wherein a step corresponding to the thickness of the spring is not formed on the mating face of the metal mold with the spring.

12. The support device for an optical element according to claim 10 wherein the linking section is provided in a plurality, and one end of at least two of the plurality of linking sections are linked by a linkage element capable of removing after insertion molding.

13. The support device for an optical element according to claim 1 wherein the optical element is a mirror.

14. The support device for an optical element according to claim 1 wherein the optical element is a lens.

15. The support device for an optical element according to claim 1 wherein the holder is a galvano-mirror capable of tilting about at least one axis with respect to the fixing unit.

16. The support device for an optical element according to claim 1 wherein the holder is moved in at least one direction parallel with the fixing unit.
